(19) United States
(12) Patent Application Publication
(10) Pub. No.: US 2015/0285286 A1
(43) Pub. Date: Oct. 8, 2015

(54) Shelf Connector and Shelving System Using Same

(71) Applicant: Cheyenne Industries LLC, Little Rock, AR (US)

(72) Inventor: Jeffrey Neuman Sanford, Fayettevill, AR (US)

(21) Appl. No.: 14/410,079

(22) PCT Filed: Jun. 21, 2013
(86) PCT No.: PCT/US13/47099

§ 371 Date: Dec. 20, 2014

Related U.S. Application Data
(63) Continuation of application No. 13/802,415, filed on Mar. 13, 2013, now abandoned.
(60) Provisional application No. 61/662,829, filed on Jun. 21, 2012.

(51) Int. Cl. F16B 12/40; A47B 57/06

(52) U.S. Cl. CPC F16B 12/40; A47B 57/06

(57) ABSTRACT

An adjustable connector includes a main body portion and a locking connector to removably engage a top portion of the main body, allowing a shelf to be connected to a support anywhere along the support. A shelving system using the adjustable connector, supports, and a shelf having engaging members for connecting to the adjustable connector is presented.

### BACKGROUND OF THE INVENTION

This application claims priority under 35 U.S.C. §119 (e) to provisional application No. 61/662,829, filed on Jun. 21, 2012, the contents of which are hereby incorporated by reference in their entirety.

### FIELD OF THE INVENTION

Shelving systems are typically modular systems that allow for limited, if any, individuality or adjustment. However, the places where the shelves are located are not always amenable to the limitations imposed by the inflexibility of the shelving systems. The shelves typically can only be adjusted up and down on a stepwise basis, and the steps may be too small or too large for the intended purpose. Therefore, there needs to be a shelving system that has an adjustable connector to allow for infinite adjustment of the shelving height. Additionally, the adjustable connector must be easy to attach to the supports and to adjust the attachment point.

### SUMMARY OF THE INVENTION

The present invention is directed to an adjustable connector for attaching a portion of a shelf to a support that includes a main connector portion having a main body, the main body having a top and a bottom and an opening extending therebetween to receive at least a portion of the support therein, the bottom having a radially-outward extending portion, at least a portion of the radially-outward extending portion having a first groove therein, the first groove partially formed by an outside portion of the main body; and a locking connector portion configured to removably engage the top portion of the main body.

In some embodiments, the locking connector portion, when connected to the top portion of the main body, forms a second groove, the second groove formed by the locking connector portion and the outside portion of the main body.

In other embodiments, the opening in the main body has a first diameter at the top and second diameter at the bottom, the first diameter being smaller than the second diameter.

In some embodiments, the top of the main body has a threaded portion and the locking connector portion also has a threaded portion to engage the threaded portion on the top of the main body.

According to another aspect of the present invention, an adjustable shelving system is provided that includes a plurality of adjustable connectors, each of the adjustable connectors comprising a connector portion having a main body, the main body having a top and a bottom and an opening extending therebetween, the bottom having a radially-outward extending portion, at least a portion of the radially-outward extending portion having a first groove therein, the first groove partially formed by an outside portion of the main body, and a locking connector portion configured to removably engage the top portion of the main body, a plurality of supports, each of the plurality of supports configured to be disposed at least partially in the opening of the adjustable connectors, and at least one shelf having a plurality of engaging members, each of the engaging members configured to engage the first groove in one of the plurality of adjustable connectors.

In yet another aspect, an adjustable connector for attaching a portion of a shelf to a support is provided, the connector includes a main connector portion having a main body, the main body having a top and a bottom and an opening extending therebetween, the bottom having a radially-outward extending portion, at least a portion of the radially-outward extending portion having a first groove therein, the first groove partially formed by an outside portion of the main body, a sleeve, the sleeve having a top, a bottom, an outer surface configured to engage the opening in the main body, and an inner surface defining an opening therethrough to receive at least a portion of the support, the inner surface configured to engage the support and the outer surface configured to engage the opening in the main connector portion, and a locking connector portion configured to removably engage the top portion of the sleeve.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of one embodiment of a shelving system using an adjustable connector according to the present invention;

FIG. 2 is an exploded partial view of the shelving system in FIG. 1 illustrating the adjustable connector and shelf with an engaging member;

FIG. 3 is an exploded partial view of another embodiment of a shelving system according to the present invention illustrating the adjustable connector and a solid shelf with an engaging member;

FIG. 4 is an exploded view of another embodiment of an adjustable connector having a sleeve according to the present invention;

FIG. 5 is an exploded view of another embodiment of an adjustable connector having a different sleeve according to the present invention;

FIG. 6 is a cross section view of the adjustable connector of FIG. 5;

FIG. 7 is a cross section view of the adjustable connector of FIG. 4 disposed on a support;

FIG. 8 is an cross section view of the adjustable connector of FIG. 2 with the shelf attached thereto;

FIG. 9 is an cross section view of another embodiment of an adjustable connector with a sleeve used with another embodiment of a shelf according to the present invention;

FIG. 10 is a cross section view of another embodiment of an adjustable connector without a sleeve according to the present invention;

FIG. 11 is cross section view of the adjustable connector of FIG. 9 disposed on a support;

FIG. 12 is a cross sectional and exploded view of another embodiment of an adjustable connector according to the present invention; and

FIG. 13 is a top view of a main body portion of another embodiment of an adjustable connector according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

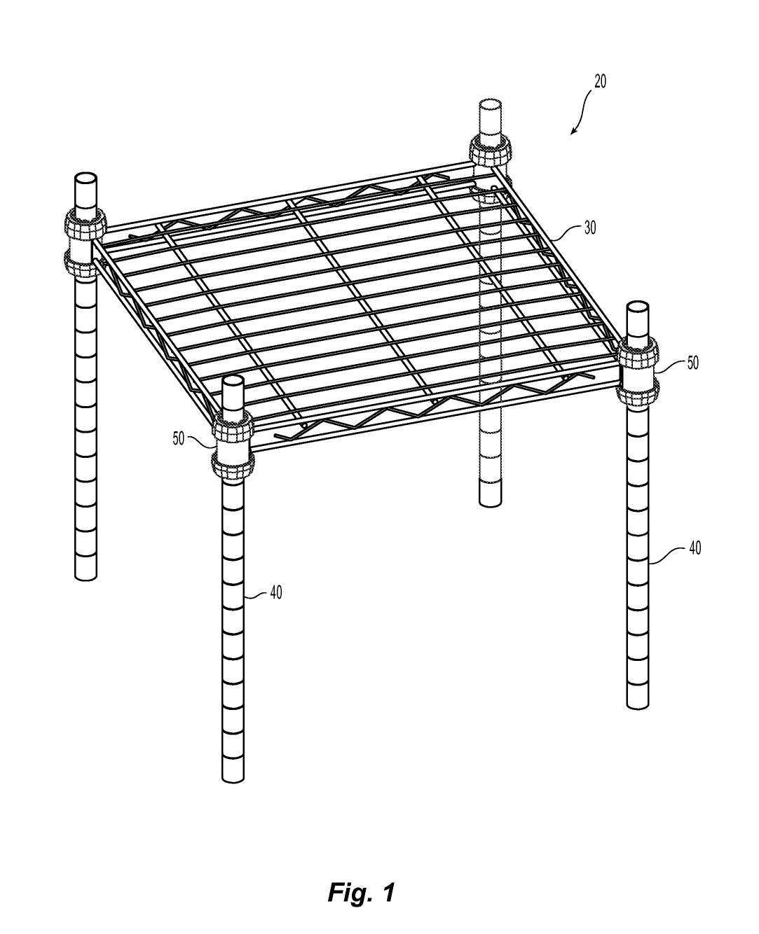

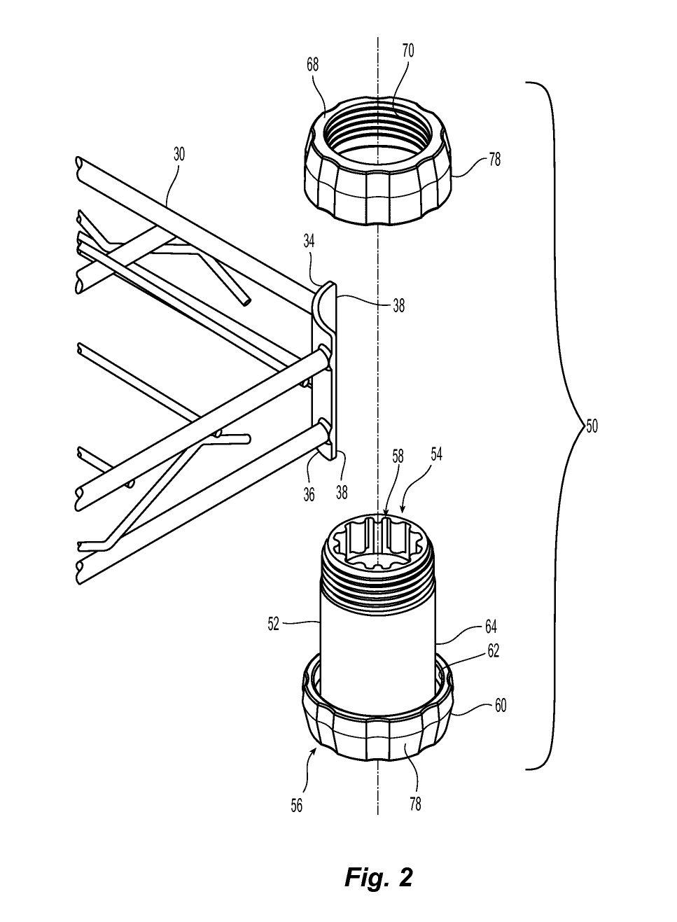

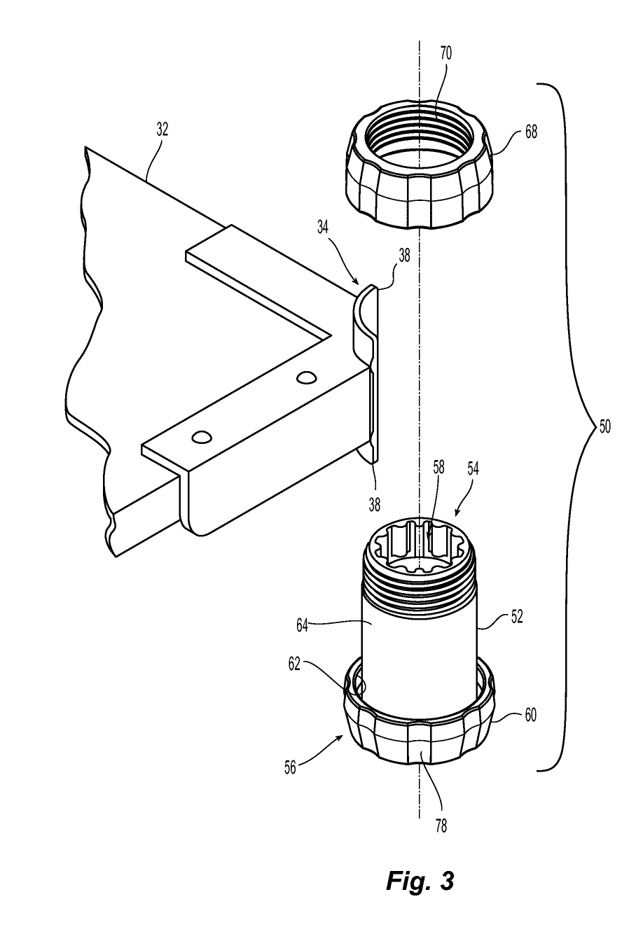

Referring to FIG. 1, a shelving system 20 has a shelf 30, a plurality of supports 40, and a corresponding number of adjustable connectors 50. The shelf 30 is illustrated as a wire shelf, which is generally known in the industry. Other configurations a wire shelf 30, different from those as illustrated in the figures, may be used with the shelving system 20 and still fall within the scope of the present invention. As an example, a solid shelf 32 as illustrated in FIG. 3 may be used. The solid shelf 32 may be constructed of any appropriate material including, but not limited to, solid wood, fiber board, melamine, plastic, and metal. As illustrated in FIGS. 2 and 3, the shelf 30 (as well as the solid shelf 32) includes an engaging member 34 that are attached at the corners 36 of the shelf 30. The engaging member 34 is preferably a thin metallic structure that approximates a quarter of a circle. The engaging member 34 also has tabs or projections 38 that extend above and below the shelf 30, 32 to engage the corresponding adjustable connector 50, as described in more detail below. The configuration of the engaging member 34 corresponds to the configuration of (more specifically, the radius of) the outer surface of the or spotting adjustable connector 50.

Referred back to FIG. 1, the plurality of supports 40 are preferably lengths of cylindrical metallic poles. As illustrated in FIG. 1, the supports 40 may have spaced indentations that function as visual indicia for the operator in placing the adjustable connectors in shelves 30. However, as would be known to one of ordinary skill in the art, the exact configuration of and the material from which supports 40 can be numerous. The supports 40 should be chosen appropriately for the size, weight (both of the shelf and for the load that can be placed on the shelf), and intended use of the shelving system 20. The diameter of the supports 40 should correspond to the openings in the adjustable connectors 50 as described in detail below.

The adjustable connectors 50 have a main body 52, the main body 52 has a top 54 and a bottom 56 with an opening 58 extending therebetween. The bottom 56 of the main body 52 has a radially-outward extending portion 60 that at least partially defines a first groove 62. The first groove 62 is also formed by an outside surface 64 of the main body 52. The 1st groove 62 is configured to receive the bottom tab 38 of the engaging member 34 on the shelf 30. As such, the groove 62 is substantially circular, but as noted below, it could have other configurations.

The adjustable connectors 50 have at the top 54 of the main body 52 a threaded portion 66 to receive a locking connector portion 68. The locking connector portion 68 also has a threaded portion 70 on an internal surface 72 thereof. The threaded portion 70 cooperates with the threaded portion 66 of the main body 52. When the locking connector portion 68 is attached to the top 54 of the main body 52, a second groove 74 is formed. See FIG. 7. The second groove 74 is also preferably formed by an outside surface 64 of the main body 52 in conjunction with the locking connector portion 68. Both the bottom 56 and the locking connector portion 68 preferably have surface treatments 78 that allow for easy gripping by the user to allow the user to rotate the bottom 56 and the locking connector portion 68 relative to one another. While grooves are illustrated in the figures, other configurations could be used and come within the scope of the present invention, e.g., knurled surfaces, bumps, etc.

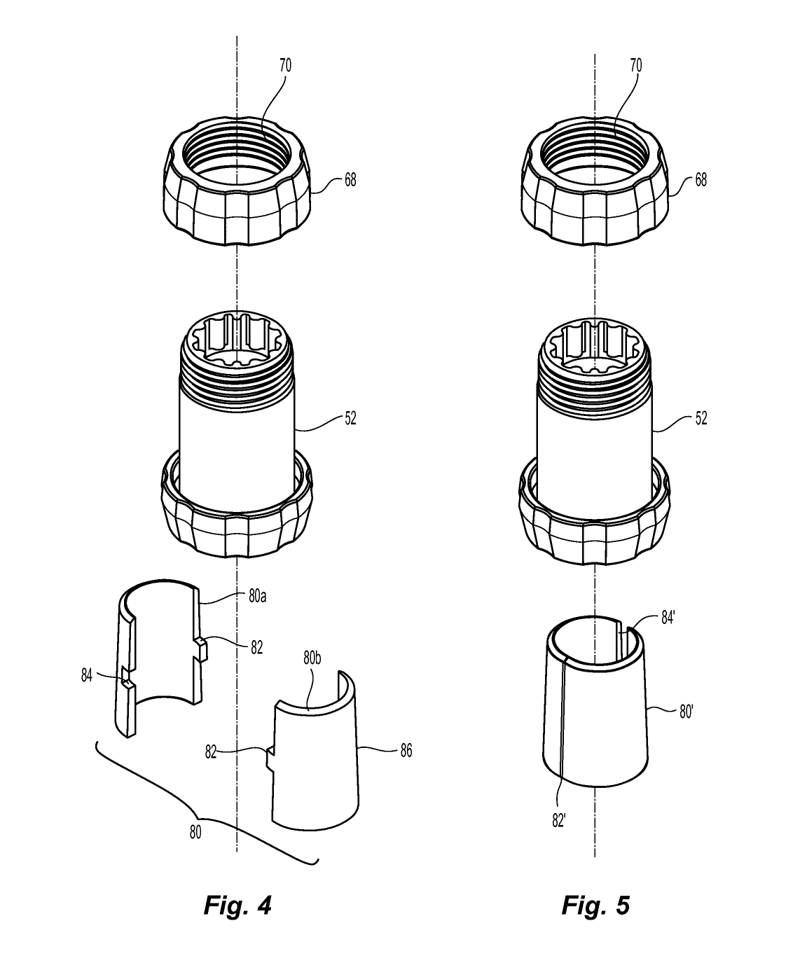

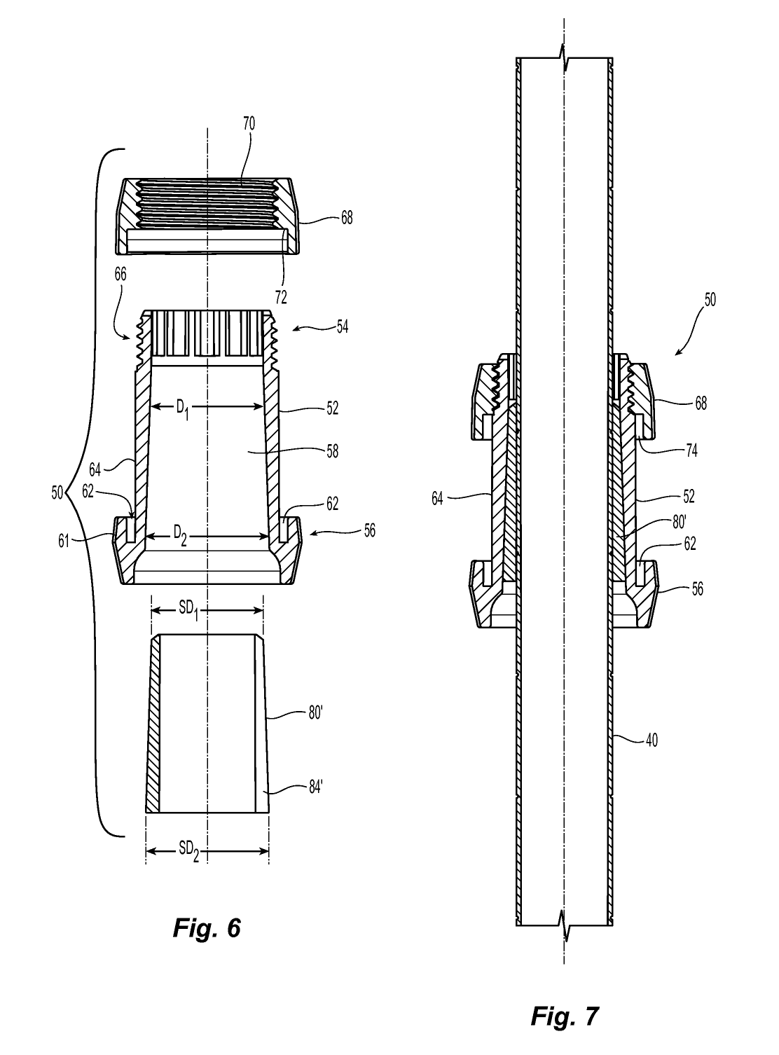

The opening 58 is sized to receive the support 40 and also a removable sleeve 80. See FIG. 4. The sleeve 80 in FIG. 4 has two pieces 80a and 80b that cooperate to form a single piece when put together and the main body 52 placed over it. The pieces 80a and 80b have a tab 82 and an indentation 84 that receives the tab 82 from the other part of the sleeve 80. The outer surface 86 of the sleeve 80 corresponds to engage the opening 58 of the main body 52. It should be noted that the opening 58 of the main body 52 has a first diameter D1 at the top 54 and a second diameter D2 at the bottom 56, the first diameter being smaller than the second diameter. Similarly, the outer diameter SD1 at the top of the sleeve 80 is smaller than the outer diameter SD2 of the sleeve 80 at the bottom, so the outer surface 86 corresponds to the opening 58.

Another embodiment of a sleeve 80′ is illustrated in FIG. 5. The sleeve 80′ is similar in most respects to the sleeve 80 in FIG. 4 except that the sleeve 80′ is a single piece with a hinge 82′ along the length thereof. The hinge 82′ may be a living hinge type, and the second side 84′ of the sleeve 80′ may be flat or have a tab/indentation to allow for the sleeve 80′ to be placed around the supports 40.

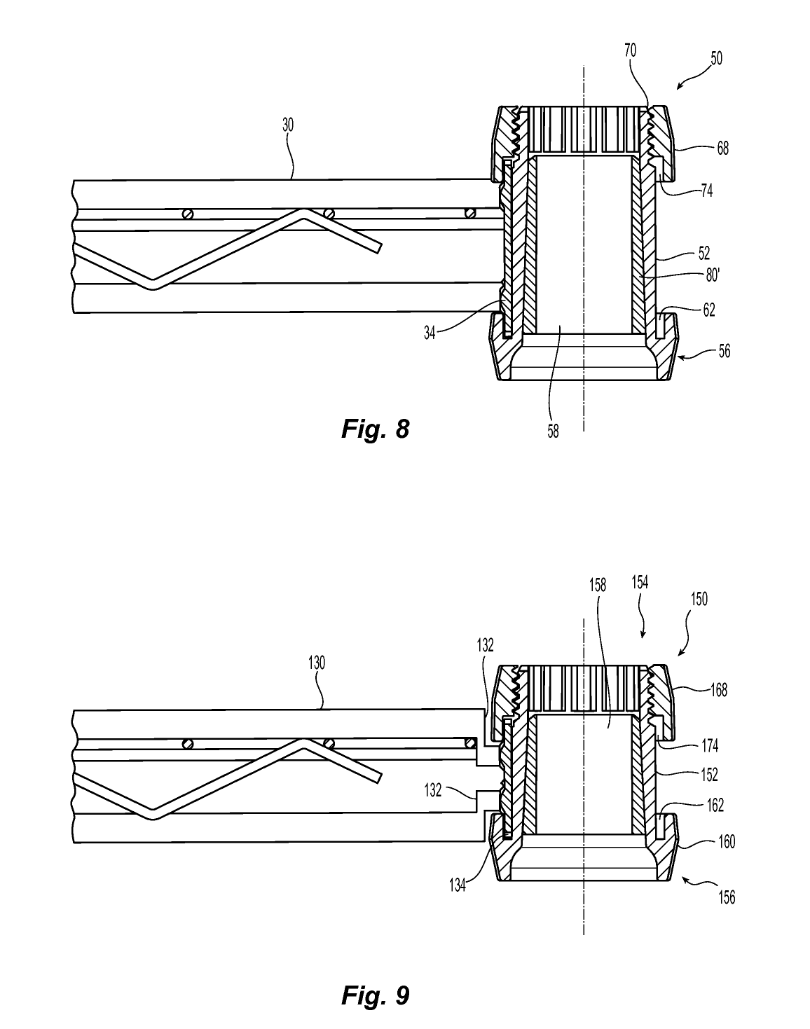

The adjustable connector 50 is illustrated in FIG. 7 on a support 40. The adjustable connector 50 has the sleeve 80′ between the main body 51 and the support 40 to provide resistance and secure the adjustable connector 50 to the support 40. As noted above, the sleeve 80′ can be located anywhere along the length of the support 40 to allow the adjustable connector 50 to placed at the precise location needed/wanted by the user. The main body 52 is placed over the top of the support 40 and engages the outer surface 86 of the sleeve 80′. The locking connector portion 68 is then placed over the top of the support 40 and threaded on to the main body 52. As will be intuitive, the engaging member 34 will be placed into the grooves 62,74 before the locking connector portion 68 is tightened such that engaging member 34 will not be able to be placed in to the grooves 62,74. See FIG. 8. The same is done on at least three (and usually four) other supports 40 to set up a shelving system 20. Each of the adjustable connectors 50 can accommodate up to four of the engaging members 34. Thus, a single support 40 could be used to support up to four different shelves 30,32, depending on the layout by the user.

The connection of the engaging member 34 to the shelves 30,32 is illustrated in FIGS. 2 and 3. However, there can be other methods of making that connection. A different method is illustrated in FIG. 9. FIG. 9 illustrates another shelf 130 that is thiner than the shelves 30,32 and has a lower profile. This allows for a lower profile adjustable connector 150 as well. While the components are the same, they are simply not as long, but would have similar dimensions to engage the support 40 as before. The shelf 130 has inwardly projecting supports 132 that engage the engaging member 134. The adjustable connector 150 has a main body 152, the main body 152 has a top 154 and a bottom 156 with an opening 158 extending therebetween. The bottom 156 of the main body 152 has a radially-outward extending portion 160 that at least partially defines a first groove 162. The first groove 162 is also formed by an outside surface 164 of the main body 152. The locking connector portion 168 attaches to the main body 152 to form the second groove 174. The sleeve 180 is also shorter, but has the same configurations and relationship to the opening 158 in the adjustable connector 150.

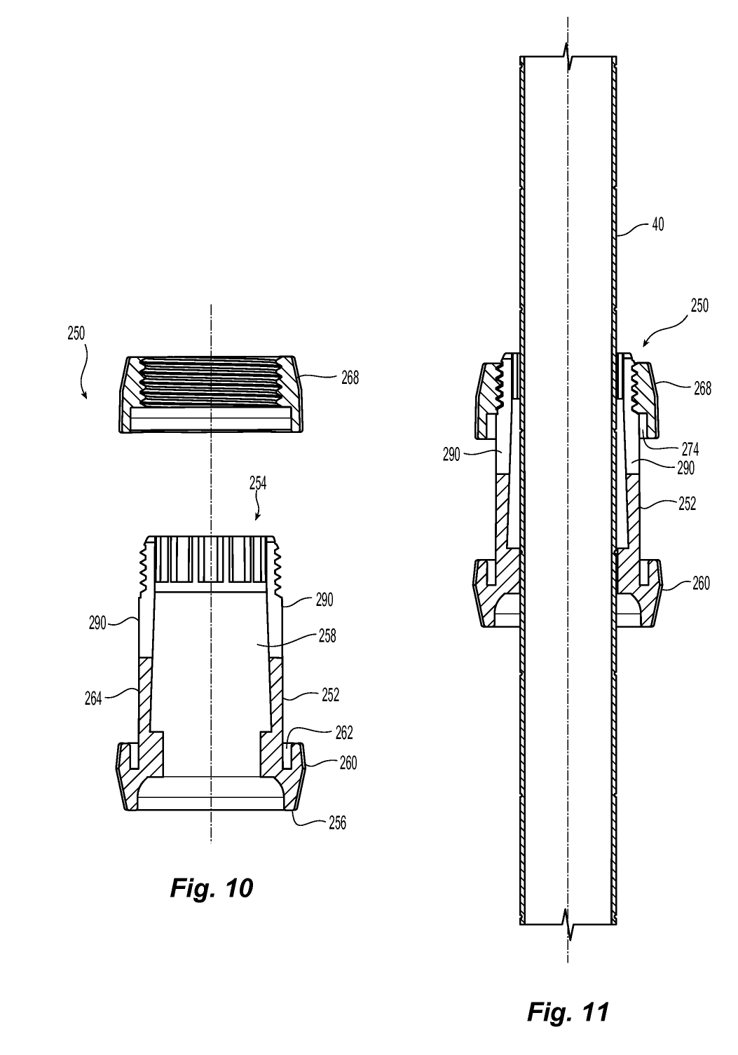

Another embodiment of an adjustable connector 250 is illustrated in FIGS. 10 and 11. The adjustable connector 250 has a main body 252, the main body 252 has a top 254 and a bottom 256 with an opening 258 extending therebetween. The bottom 256 of the main body 252 has a radially-outward extending portion 260 that at least partially defines a first groove 262. The first groove 262 is also formed by an outside surface 264 of the main body 252. The locking connector portion 268 attaches to the main body 252 to form the second groove 274. The adjustable connector 250 does not have a sleeve that is used to secure the adjustable connector to the support 40. See FIG. 11. Rather, the main body 252 has two openings 290 therein that extend from the top 254 to a middle portion of the main body 252. There are preferably two openings 290 in the main body 252 and they are preferably on opposite sides of the main body 252. However, there could more or fewer openings and located in different locations about the main body 252 and still come within the scope of the present invention. Thus, with the two openings 290 on opposites sides of the main body 252, when the locking connector portion 268 is secured to the top 254, it causes the two top portions of the main body 252 (caused by the openings 290 extending downward from the top 254) to be squeezed inward and causes the main body of the adjustable connector 250 to engage the supports 40 directly.

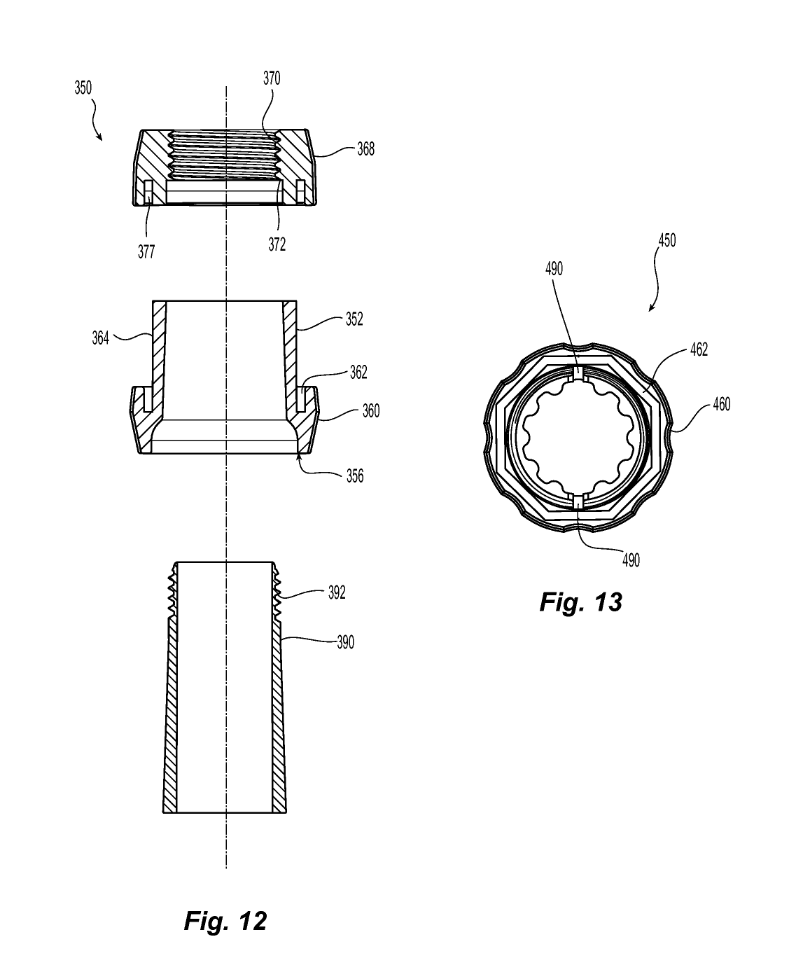

Another embodiment of an adjustable connector 350 is illustrated in FIG. 12. The adjustable connector 350 has a main body 352, the main body 352 has a bottom 356 with a radially-outward extending portion 360 that at least partially defines a first groove 362. The first groove 362 is also formed by an outside surface 364 of the main body 352. The adjustable connector 350 has a sleeve 390 that has a threaded portion 392 at the top to receive a locking connector portion 368. The locking connector portion 368 also has a threaded portion 370 on an internal surface 372 thereof. The locking connector portion 368 has formed therein the second groove 374. The sleeve 390 is placed on to the support 40 and then the main body 352 is placed on top of the sleeve 390. The locking connector portion 368 is placed on the support 40 and aligned with the top of the sleeve 390. The engaging members of the shelves are inserted into the first and second grooves 362,374 and then the locking connector portion 368 is secured to the sleeve 390, locking the adjustable connector 350 into place.

FIG. 13 illustrates another embodiment of an adjustable connector 450 according to the present invention. Adjustable connector 450 is illustrated from the top looking down into the first groove 462 formed at least in part by the radially-outward extending portion 460. The adjustable connector 450 also has the openings 490 that allow for direct engagement with the supports 40. However, the first groove 462 could also be incorporated into the other adjustable connectors as well. The first groove 462 has a plurality of straight segments rather than being generally circular. This configuration of the first groove 462 would allow for the engaging members to have at least one flat surface, rather than the curved, quarter round configuration illustrated above.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. An adjustable connector for attaching a portion of a shelf to a support comprising:
a main connector portion having a main body, the main body having a top and a bottom and an opening extending therebetween to receive at least a portion of the support therein, the bottom having a radially-outward extending portion, at least a portion of the radially-outward extending portion having a first groove therein, the first groove partially formed by an outside portion of the main body and an upward extending portion of the radially-outward extending portion; and
a locking connector portion configured to removably engage the top of the main body, wherein the locking connector portion, when connected to the top of the main body, forms a second groove, the second groove formed by the locking connector portion and the outside portion of the main body.

2. (canceled)

3. The adjustable connector according to claim 1, further comprising a sleeve, the sleeve having an outer surface configured to engage the opening in the main body and an inner surface defining an opening therethrough, the inner surface configured to engage the support.

4. The adjustable connector according to claim 1, wherein the opening in the main body has a first diameter at the top and second diameter at the bottom, the first diameter being smaller than the second diameter.

5. The adjustable connector according to claim 3, wherein the sleeve has a first outer diameter at a top end thereof and a second outer diameter at a bottom end thereof, the first outer diameter being smaller than the second outer diameter.

6. The adjustable connector according to claim 5, wherein the outer diameters of the sleeve are substantially the same as diameters of the opening in the main body.

7. The adjustable connector according to claim 1, wherein the top of the main body has a threaded portion and the locking connector portion also has a threaded portion to engage the threaded portion on the top of the main body.

8. The adjustable connector according to claim 7, wherein the threaded portion is on an outside surface of the main body.

9. The adjustable connector according to claim 1, wherein the first groove is configured to receive at least a portion of a shelf therein.

10. The adjustable connector according to claim 1, wherein the first groove and the second groove are substantially circular.

11. The adjustable connector according to claim 1, wherein the first groove and the second groove have a least one substantially straight portion.

12. An adjustable shelving system comprising:
a plurality of adjustable connectors, each of the adjustable connectors comprising a connector portion having a main body, the main body having a top and a bottom and an opening extending therebetween, the bottom having a radially-outward extending portion, at least a portion of the radially-outward extending portion having a first groove therein, the first groove partially formed by an outside portion of the main body, and a locking connector portion configured to removably engage the top of the main body;
a plurality of supports, each of the plurality of supports configured to be disposed at least partially in the opening of the adjustable connectors; and
at least one shelf having a plurality of engaging members, each of the engaging members configured to engage the first groove in one of the plurality of adjustable connectors, wherein the locking connector portion. when connected to the top of the main body, forms a second groove, the second groove formed by the locking connector portion and the outside portion of the main body and each of the engaging members are configured to engage the first and second grooves in each of the plurality of adjustable connectors.

13. The adjustable shelving system according to claim 12, wherein the plurality of supports comprises at least three supports.

14. The adjustable shelving system according to claim 12, wherein each of the plurality of supports is configured to be disposed within at least two of the plurality of the adjustable connectors.

15. (canceled)

16. An adjustable connector for attaching a portion of a shelf to a support comprising:
a main connector portion having a main body, the main body having a top and a bottom and an opening extending therebetween, the bottom having a radially-outward extending portion, at least a portion of the radially-outward extending portion having a first groove therein, the first groove partially formed by an outside portion of the main body;
a sleeve, the sleeve having a top, a bottom, an outer surface configured to engage the opening in the main body, and an inner surface defining an opening therethrough to receive at least a portion of the support, the inner surface configured to engage the support and the outer surface configured to engage the opening in the main connector portion; and
a locking connector portion configured to removably engage the top of the sleeve, wherein the locking connector portion, when connected to the top of the main body, forms a second groove, the second groove formed by the locking connector portion and the outside portion of the main body.

17. The adjustable connector according to claim 16, wherein the the sleeve has a first outer diameter at a top end thereof and a second outer diameter at a bottom end thereof, the first outer diameter being smaller than the second outer diameter.

18. The adjustable connector according to claim 16, wherein the top of the sleeve has a threaded portion and the locking connector portion also has a threaded portion to engage the threaded portion on the top of the sleeve.
